(19) United States
(12) Patent Application Publication
(10) Pub. No.: US 2014/0004006 A1
(43) Pub. Date: Jan. 2, 2014

(54) SENSOR FOR MEASURING SOOT OF DIESEL VEHICLE

(71) Applicant: HYUNDAI MOTOR COMPANY, Seoul (KR)

(72) Inventor: Cheol Beom LIM, Hwaseong-si (KR)

(73) Assignee: Hyundai Motor Company, Seoul (KR)

(21) Appl. No.: 13/683,691

(22) Filed: Nov. 21, 2012

(30) Foreign Application Priority Data
Jun. 29, 2012 (KR) 10-2012-0071123

(51) Int. Cl. G01N 25/28

(52) U.S. Cl. CPC G01N 25/28
USPC 422/94

(57) ABSTRACT

A sensor for measuring soot of a diesel engine includes an exothermic element that consists of TiO₂ support to which Ag is fixed and is combustion-reacted with the sort of exhaust gas, a comparison element that consists of TiO₂ support and is not combustion-reacted with the soot of exhaust gas, and a measuring section for deducing the soot formation amount by using the temperature difference between the exothermic element and the comparison element.

### CROSS-REFERENCE TO RELATED APPLICATION

The present application claims priority of Korean Patent Application Number 10-2012-0071123 filed Jun. 29, 2012, the entire contents of which application is incorporated herein for all purposes by this reference.

### BACKGROUND OF INVENTION

1. Field of Invention

The present disclosure relates to a sensor for measuring soot discharged from a diesel engine by using a positive and highly combustion-active element.

2. Description of Related Art

Generally, in a Diesel Particulate Filter (“DPF”) system the Particulate Matters (“PM”) remaining in a exhaust gas of a diesel engine are collected physically by using a filter and then PM is burnt out by increasing a temperature of the exhaust gas to an combustion temperature of PM or more after a vehicle travels at a predetermined distance.

The DPF system has been kwon as the best efficient technology for removing the soot among PM, however, an additional back pressure has to be applied to an engine and further the additional energy consumption is necessary for burning and reproducing periodically the traped-soot since the exhaust gas temperature has to be increased under the DPF system thereby affecting adversely fuel efficiency. Further, the discharged soot is affected greatly by an engine operation condition.

Accordingly, there needs a technology for sensing discharging amount of soot in real time in order to operate efficiently an engine and optimize DPF operation period.

Meanwhile, according to a related art, an optical sensor has been mainly used for sensing the soot and recently a Radio Frequency (“RF”) sensor has been proposed, however, a sensor for sensing the soot that is possible to be mounted practically on a vehicle has not developed yet.

Accordingly, a development of a contact combustion type diesel soot sensor of a new concept that is applicable to a vehicle is necessary and further a development of an element having selectively high combustion activity with respect to the soot is essential for implementing the contact combustion type soot sensor.

The description provided above as a related art of the present invention is just for helping understanding the background of the present invention and should not be construed as being included in the related art known by those skilled in the art.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a sense for measuring soot of a diesel engine to which a positive and highly combustion-active element with respect to the soot among PM in exhaust gas discharged from the diesel engine.

Various aspects of the present invention provide for a sensor for measuring soot of a diesel engine, comprising an exothermic element that consists of TiO₂ support to which Ag is fixed and is combustion-reacted with the sort of exhaust gas, a comparison element that consists of TiO₂ support and is not combustion-reacted with the soot of exhaust gas, and a measuring section for deducing the soot formation amount by using the temperature difference between the exothermic element and the comparison element.

The exothermic element may comprise Ag 1-7wt % in TiO₂.

The exothermic element may be prepared using an impregnation process, a drying process and a heat-treatment process.

The impregnation process may be performed by immersing TiO₂ into AgNo₃ precursor solution for Ag to be fixed to TiO₂ support.

The drying process may be performed at 60-100° C. for 6-20 hours after the impregnation process.

The heat-treatment process is performed at 500-700° C. for 2-5 hours after the drying process.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a sensor for measuring soot of an exemplary diesel engine according to the present invention.

FIG. 2 is a view showing a manufacturing method of an exothermic element for the sensor for measuring soot of a diesel engine as shown in FIG. 1.

FIG. 3 is a graph showing a measuring method of soot formation amount by using the temperature difference between the exothermic element in the sensor for measuring soot of a diesel engine as shown in FIG. 1 and a comparison element.

It should be understood that the appended drawings are not necessarily to scale, presenting a somewhat simplified representation of various features illustrative of the basic principles of the invention.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

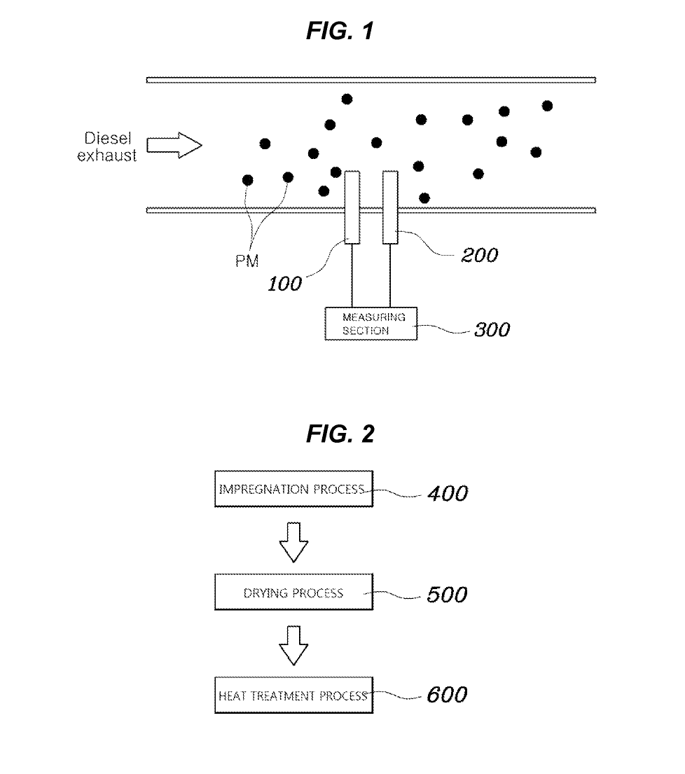

FIG. 1 is a view showing a sensor for measuring soot of a diesel engine according to various embodiments of the present invention, referring to FIG. 1, the sensor for measuring soot of a diesel engine includes an exothermic element 100 that consists of TiO₂ support to which Ag is fixed and heated with combustion-reacted with the soot of exhaust gas, a comparison element 200 that consists of the TiO₂ support and is not burnt with the soot of exhaust gas, and a measurement section 300 for deducing a soot formation amount by using a temperature difference between the exothermic element and the comparison element.

The present invention relates to a sensor for measuring the soot by using a element having a positive and high combustion-activity with respect to the soot, capable of sensing positively in real time the soot discharging amount among PM in exhaust gas discharged from a diesel engine.

That is, the sensor for measuring soot consists of the exothermic element 100 having highly combustion-activity with respect to the soot and the comparison element 200 having combustion inactivity with respect to the soot, and deduces the soot discharging amount by measuring heating amount and a temperature difference between the comparison element 200 and the exothermic element while the exothermic element 100 is combustion-reacted with the soot.

Here, the exothermic element 100 consists of Ag that is combustion-reacted selectively with the soot and is high catalytic-reacted with the soot and TiO₂ support.

Meanwhile, the comparison element 200 consisting only TiO₂ support that is not combustion-reacted with respect to the soot is provided as comparison means for measuring the amount of combustion heat produced from a combustion reaction of the exothermic element 100 with the soot.

As described above, the exothermic element 100 and the comparison element consist mainly of TiO₂ and Ag that is high combustion-activated with respect to the soot is immersed into TiO₂ support of the exothermic element 100 and thus the soot formation amount can be measured by using the temperature difference caused from the combustion reaction with respect to the soot.

Accordingly, in consideration of TiO₂ constituting the support of the exothermic element 100 and the comparison element 200, the temperature difference between before measuring the soot of the exothermic element 100 and the comparison element 200 and after the soot is formed is not produced, that is, the temperature is same between them. However, in consideration of Ag,

in case where the soot is formed in the exhaust gas, Ag of the exothermic element 100 is combustion-reacted with the soot and the amount of the produced combustion heat is measured accurately comparing to the comparison element 200 where the exothermic element 100 and the comparison element 200 are under same condition.

Therefore, the sensor for measuring the soot of a diesel engine is provided with the exothermic element 100 in which Ag having highly combustion-activity with respect the soot is fixed to TiO₂ support and the comparison element 200 consisting of TiO₂ support that is not combustion-reacted with respect to the soot thereby sensing positively the soot formation amount by using the temperature variation of the respective sensor and temperature difference between the respective sensor.

FIG. 2 is a view showing a manufacturing method of the exothermic element 100 for the sensor for measuring soot of a diesel engine as shown in FIG. 1 wherein the exothermic element 100 consists of TiO₂ comprising Ag 1-7 wt %. As described above, the exothermic element comprising TiO₂ as the immersion metal comprises Ag and thus is combustion-reacted with respect to the soot to produce heat.

Of course, even though Ag of 7 wt % or more may be comprised, but the combustion reaction amount is not increased proportionally to the increasing range of Ag, and thus proper range of Ag may be comprised preferably. Here, in case where the immersion amount of Ag is 5 wt %, the optimal combustion-activity and catalytic activity with respect to the soot is appeared and thus Ag 5 wt % may be immersed in TiO₂.

As shown in FIG. 2, the exothermic element 100 may be prepared through an impregnation process 400, a drying process 500 and a heat treatment process 600.

The impregnation process 400 is performed such that the TiO₂ support is immersed in AgNO₃ solution for Ag to be fixed to the TiO₂ support. At this time, Ag is fixed to the TiO₂ support by using impregnation method. Of course, the element may be prepared by using co-precipitation method or ion-exchanging method or the like, however, in the present invention, the element may be prepared by using the impregnation method since it is simple to prepare easily the element.

The drying process 500 is performed at 60-100° C. for 6-20 hours after the impregnation process 400. The drying conditions may be such that after Ag is impregnated into the TiO₂ support through the impregnation process 400, and then it may be dried at 100° C. for 20 hours in the drying process 500. If the temperature condition is not satisfied, NO₃ in AgNO₃ precursor solution may not be vaporized or elementic activity may be decreased, and thus it may be dried at 100° C. for 20 hours.

The heat treatment process 600 may be performed such that it is heat-treated at 500-700° C. for 2-5 hours. Specially, the heat treatment process may be performed at 700° C. for 5 hours.

The exothermic element 100 is prepared by using the above processes and further the comparison element 200 consists of pure TiO₂ and is prepared as the support that is stable and combustion-inactive with respect to the soot in order to deduce the temperature according to the combustion reaction thereby deducing the soot formation amount by comparing the temperature difference between the exothermic element that is combustion-reacted with respect to the soot and the comparison element.

The measuring section 300 measures the discharged soot formation amount by using a contact combustion type sensor that can convert the temperature difference into an electric signal while the soot formation amount is deduced by using the temperature difference between the exothermic element 100 and the comparison element 200. That is, the temperature difference between the exothermic element 100 and the comparison element 200 is converted into an electric signal and the electric signal is sensed to confirm the soot amount in real time thereby managing promptly the problems caused from great or small amount of the soot.

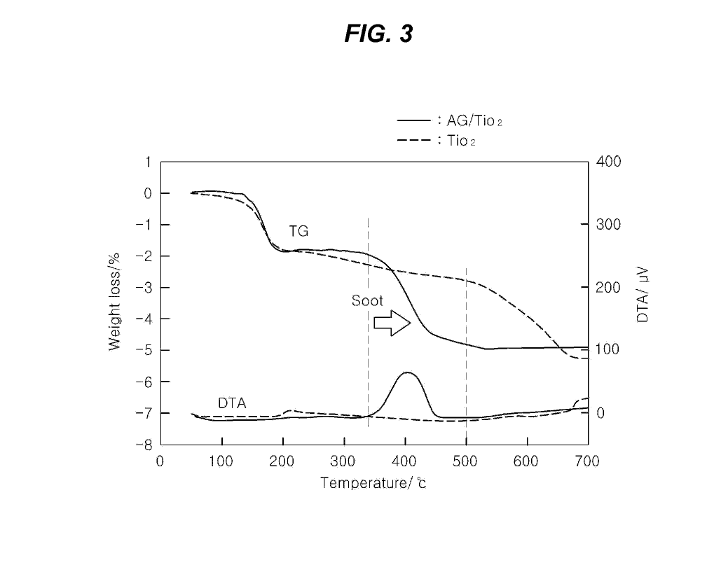

FIG. 3 is a graph showing a measuring method of soot formation amount by using the temperature difference between the exothermic element 100 in the soot measuring sensor of a diesel engine as shown in FIG. 1 and a comparison element 200 wherein the graph is made based on simulation data of combustion activity of the elements with respect to the soot. Here, it is shown that PM mass decreases due to temperature variation while the soot is formed wherein Ag/TiO₂ is the exothermic element 100 and TiO₂ is the comparison element 200.

In more detailed description of FIG. 3, Temperature/° C. on a bottom side of the graph are the temperatures of the exothermic element 100 and the comparison element 200 and the soot combustion formation heat is produced while they are kept at 370-500° C. Of course, in case where the temperature of the exothermic element 100 and the comparison element 200 increases further to 500° C. or more, the combustion reaction of the soot is promoted more progressively, but the effect of the combustion reaction is small in comparison to the temperature increasing amount and thus the temperature of the exothermic element 100 and the comparison element 200 is set to 370-500° C. in range of which the element activity to the soot combustion reaction is optimal to measure the soot amount.

As an experimental method for confirming the combustion activity of the exothermic element Ag/TiO₂ with respect to the soot, Thermogravimetry (“TG”) and Differential Thermal Analysis (“DTA”) have been used.

First, in more detailed description of the confirmation method of the combustion activity of the exothermic element with respect to the soot by using TG measuring method, the weight loss/% on a left side of the graph demonstrates that PM is burnt in the presence of the exothermic element 100 Ag/TiO₂ and the mass thereof decreases. Further, in case where the respective element sensor temperature is kept at 500° C., the combustion-activity of the element with respect to the soot is confirmed to be high. Specially, for example, in case where weight ratio of the exothermic element 100 Ag/TiO₂ to PM is 95:5, Ag of the exothermic element 100 Ag/TiO₂ is combustion-reacted with PM of the soot as an oxidation reaction to produce heat and a total mass of 5 wt % is decreased wherein 3 wt % decrease is caused from the oxidation reaction of the soot and 2 wt % decrease before the decrease of the soot mass is caused from vaporization of SOF of PM. Specially, in case that the temperature of Ag/TiO₂ exothermic element 100 and TiO₂ comparison element 200 is 500° C., it is shown that the resulted weight difference between them is large since the exothermic element is combustion-activated to the soot.

Accordingly, as shown in FIG. 3, Ag/TiO₂ exothermic element 100 is combustion-reacted selectively to the soot to be oxidized and thus it is shown that the weight is decreased significantly, comparing to the weight decrease in TiO₂. That is, through this experiment, it is confirmed that Ag/TiO₂ exothermic element 100 is combustion-reacted selectively to the soot.

Meanwhile, in detailed description of a combustion-activity to the soot by using DTA measuring method, the DTA/μV on right side of FIG. 3 shows that voltage increases depending on temperature increase when Ag/TiO₂ exothermic element 100 is combustion-reacted to the soot and temperature increases. Specially, high combustion formation heat is produced through the combustion-reaction to the soot in Ag/TiO₂ exothermic element 100, but the combustion-reaction to the soot is not made in TiO₂ comparison element 200 and thus the combustion formation heat is not produced. As a result, the temperature difference between Ag/TiO₂ exothermic element 100 and TiO₂ comparison element 200 is produced ant the temperature difference is converted into electric signal thereby deducing the soot formation amount depending on the temperature difference.

That is, as shown in FIG. 3, it is confirmed that Ag/TiO₂ exothermic element 100 is combustion-reacted to the soot and combustion formation heat is produced and thus voltage increases abruptly, comparing pure TiO₂ comparison element 200. Accordingly, it is confirmed that Ag/TiO₂ exothermic element 100 has higher combustion-activity to the soot than TiO₂ comparison element 200.

Trough the above experiment, element that is combustion-activated selectively to the soot is confirmed and sensors consisting of the element with combustion-activity to the soot and the element with combustion-inactivity to the soot are provided thereby sensing positively and selectively the soot formation of the soot among PM in exhaust gas discharged.

According to the sensor for measuring soot of a diesel engine as set forth above, the soot formation amount can be measured by applying the positive and highly combustion-active element with respect to the soot among PM in exhaust gas discharged from a diesel engine.

Specially, a element sensor consisting of material having high combustion-activity with respect to the soot and a element sensor consisting of material having combustion-inactivity with respect to the soot are provided to sense positively the soot formation amount by using temperature vibration and temperature difference.

For convenience in explanation and accurate definition in the appended claims, the terms left or right, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A sensor for measuring soot of a diesel engine, comprising:
an exothermic element that consists of TiO₂ support to which Ag is fixed and is combustion-reacted with the sort of exhaust gas;
a comparison element that consists of TiO₂ support and is not combustion-reacted with the soot of exhaust gas; and
a measuring section for deducing a soot formation amount by using a temperature difference between the exothermic element and the comparison element.

2. The sensor for measuring soot of a diesel engine of claim 1, wherein the exothermic element comprises Ag 1-7 wt % in TiO₂.

3. The sensor for measuring soot of a diesel engine of claim 1, wherein the exothermic element is prepared with an impregnation process, a drying process and a heat-treatment process.

4. The sensor for measuring soot of a diesel engine of claim 3, wherein the impregnation process is performed by immersing TiO₂ into AgNo₃ precursor solution for Ag to be fixed to TiO₂ support.

5. The sensor for measuring soot of a diesel engine of claim 3, wherein the drying process is performed at 60-100° C. for 6-20 hours after the impregnation process.

6. The sensor for measuring soot of a diesel engine of claim 3, wherein the heat-treatment process is performed at 500-700° C. for 2-5 hours after the drying process.
